(19) United States
(12) Patent Application Publication
(10) Pub. No.: US 2012/0255141 A1
(43) Pub. Date: Oct. 11, 2012

(54) Castor Assembly

(76) Inventors: Ming-Hsien Lin, Yongkang City (TW); Feng-Hsi Yang, Tainan City (TW); Po-Lu Chen, Yongkang City (TW)

(21) Appl. No.: 13/080,719

(22) Filed: Apr. 6, 2011

(51) Int. Cl. B60B 33/00

(52) U.S. Cl. 16/45

(57) ABSTRACT

A castor assembly includes a support unit, a frame unit, a brake unit, and an operation unit. The frame unit includes a frame, a locating flange, and a wheel. The support unit includes a bearing, and an inner bushing. The brake unit includes a control shaft, a braking block, a lower toothed disk, an upper toothed disk, a locking block, and an elastic member. The operation unit includes a housing, a drive seat, a pressing roll, a cam block, and a restoring member. Thus, when the braking block presses the wheel to stop movement of the wheel, the upper toothed disk meshes with the lower toothed disk to lock the lower toothed disk and the braking block so that the wheel is locked and cannot be turned freely when the wheel is braked.

### BACKGROUND OF THE INVENTION

1. Field of the Invention

The present invention relates to a wheeled vehicle and, more particularly, to a castor assembly for a cart, trolley, chair, wheelchair and the like.

2. Description of the Related Art

A conventional castor assembly comprises a shaft, a mounting bracket pivotally mounted on the shaft and a wheel rotatably mounted on the mounting bracket. The shaft is mounted on the bottom of an object, such as a chair, cart and the like. In practice, when the castor assembly is moved, the wheel is rotated on the mounting bracket, and the mounting bracket is rotated on the shaft. Thus, the castor assembly is moved freely so as to support and move the object. However, the castor assembly does not have a braking function so that the object is not positioned in place exactly and stably, thereby causing inconvenience to the user.

### BRIEF SUMMARY OF THE INVENTION

In accordance with the present invention, there is provided a castor assembly, comprising a support unit, a frame unit pivotally connected with the support unit, a brake unit pivotally connected with the support unit and detachably locked onto the frame unit to releasably brake the frame unit, and an operation unit mounted on the support unit and connected with the brake unit to drive the brake unit relative to the frame unit.

The frame unit includes a frame having an upper end provided with a mounting hole, a locating flange mounted in the mounting hole of the frame and having a bottom provided with a locating groove, and a wheel rotatably mounted on a lower end of the frame. The support unit includes a bearing mounted in the mounting hole of the frame, and an inner bushing having a lower end mounted in the bearing. The brake unit includes a control shaft movably mounted in the inner bushing of the support unit, a braking block mounted on a lower end of the control shaft to move in concert with the control shaft and movable to press the wheel of the frame unit, a lower toothed disk mounted on the braking block, an upper toothed disk locked onto the lower end of the control shaft and movable to mesh with the lower toothed disk, a locking block formed on the upper toothed disk and detachably locked in the locating groove of the locating flange so that the locating flange and the frame of the frame unit are locked onto the locking block, and an elastic member biased between the braking block and the upper toothed disk to push the upper toothed disk away from the lower toothed disk. The operation unit includes a housing secured on the inner bushing of the support unit, a drive seat movably mounted in the housing and connected with the control shaft to drive the control shaft of the brake unit relative to the inner bushing of the support unit, a pressing roll mounted on the drive seat, a cam block rotatably mounted in the housing and abutting the pressing roll to press the pressing roll and the drive seat toward the control shaft of the brake unit, and a restoring member biased between the inner bushing of the support unit and the drive seat to push the drive seat away from the control shaft of the brake unit.

According to the primary advantage of the present invention, when the pressing face of the braking block presses the wheel to stop movement of the wheel, the upper toothed disk meshes with the lower toothed disk to lock the lower toothed disk and the braking block so that the wheel is locked and cannot be turned freely when the wheel is braked.

According to another advantage of the present invention, the braking block and the lower toothed disk are formed integrally so that the lower toothed disk will not be detached from the braking block when the upper toothed disk engages the lower toothed disk too tightly due to an excessive reaction force from the wheel.

According to a further advantage of the present invention, the wheel is oriented, braked, moved and turned by operation of the cam block to facilitate a user operating the wheel.

According to a further advantage of the present invention, the control shaft of the brake unit is directly inserted into and mounted in the frame of the frame unit so that the castor assembly is assembled easily and quickly.

According to a further advantage of the present invention, the castor assembly has a simplified construction and has a solid and stable structure.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a castor assembly in accordance with the preferred embodiment of the present invention.

FIG. 2 is a partially exploded perspective view of the castor assembly as shown in FIG. 1.

FIG. 3 is a partially exploded perspective view of the castor assembly as shown in FIG. 1.

FIG. 4 is a partially exploded perspective view of the castor assembly as shown in FIG. 1.

FIG. 5 is a side cross-sectional view of the castor assembly as shown in FIG. 1.

FIG. 6 is a cross-sectional view of the castor assembly taken along line 6-6 as shown in FIG. 5.

FIG. 7 is a schematic operational view of the castor assembly as shown in FIG. 5.

FIG. 8 is a schematic operational view of the castor assembly as shown in FIG. 7.

### DETAILED DESCRIPTION OF THE INVENTION

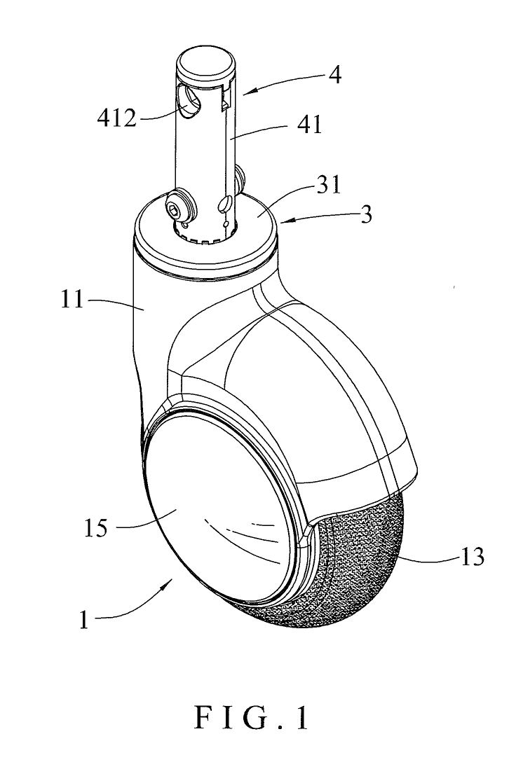

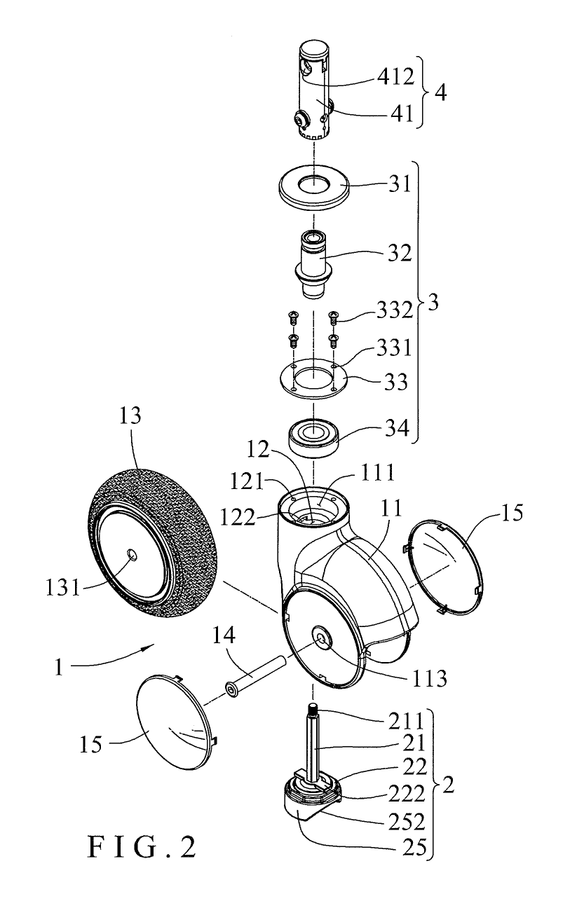

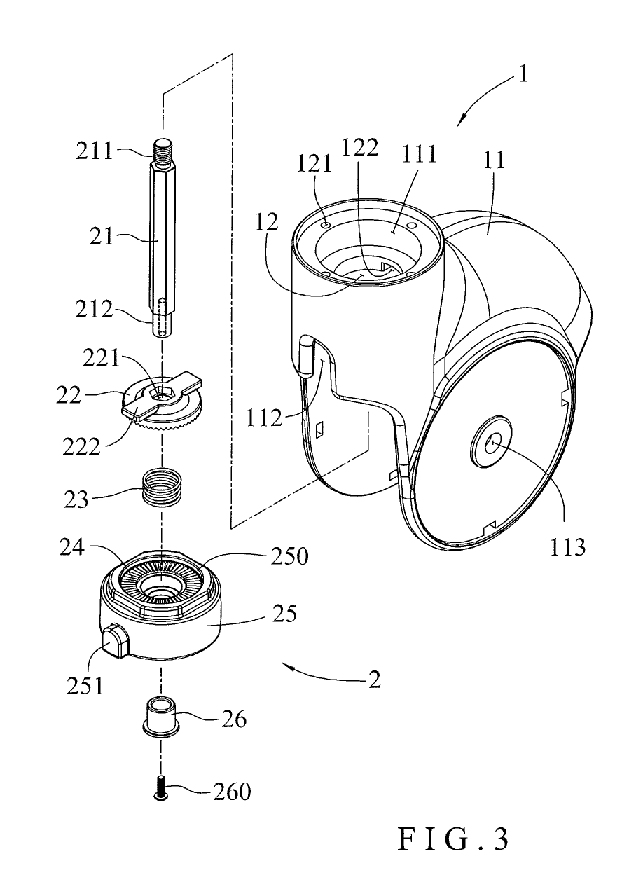

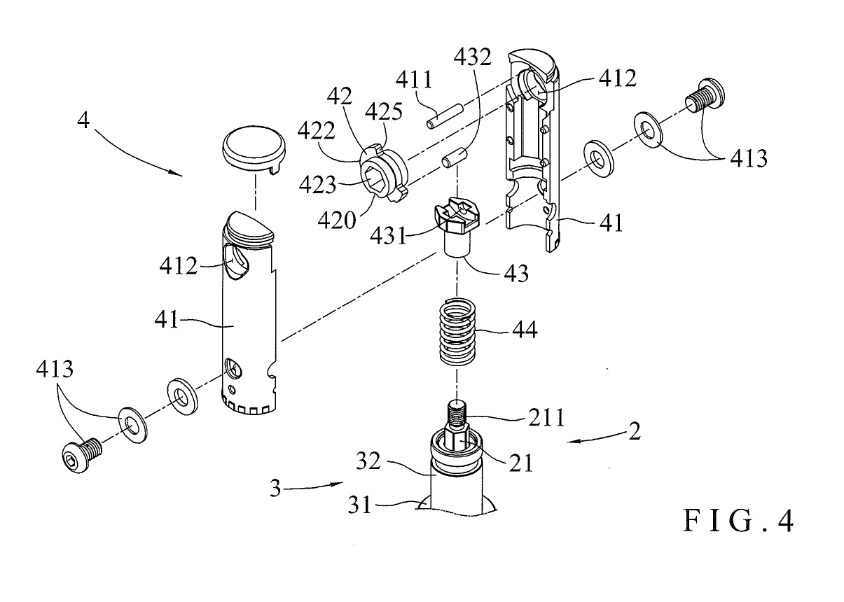

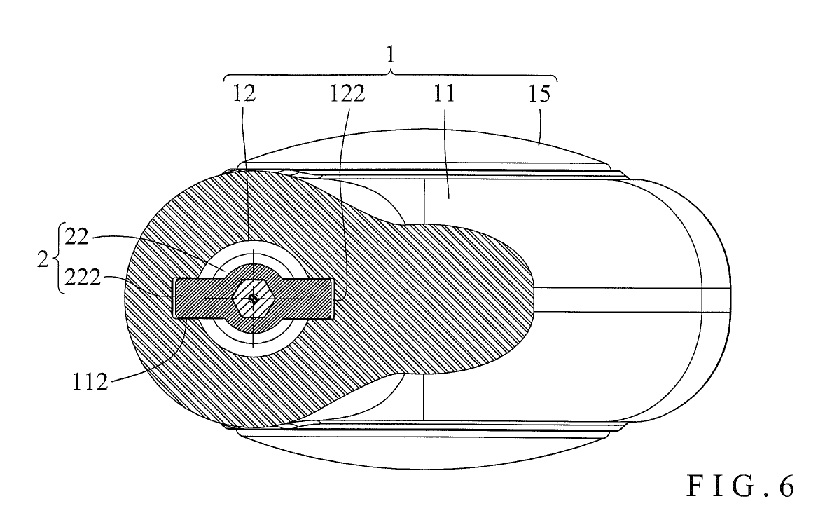

Referring to the drawings and initially to FIGS. 1-6, a castor assembly in accordance with the preferred embodiment of the present invention comprises a support unit 3, a frame unit 1 pivotally connected with the support unit 3, a brake unit 2 pivotally connected with the support unit 3 and detachably locked onto the frame unit 1 to releasably brake the frame unit 1, and an operation unit 4 mounted on the support unit 3 and connected with the brake unit 2 to drive the brake unit 2 relative to the frame unit 1.

The frame unit 1 includes a frame 11 having an upper end provided with a mounting hole 111, a locating flange 12 mounted in the mounting hole 111 of the frame 11 and having a bottom provided with a locating groove 122, a wheel 13 rotatably mounted on a lower end of the frame 11, a shaft 14 extended through the frame 11 and the wheel 13, and two side covers 15 mounted on two opposite sides of the frame 11 to cover the shaft 14.

The locating flange 12 and the mounting hole 111 of the frame 11 are formed integrally. The locating flange 12 of the frame unit 1 has a stepped hollow inside and has a top provided with a plurality of screw bores 121. The frame 11 of the frame unit 1 has a substantially inverted U-shaped profile and has a periphery provided with a positioning recess 112. Each of the two opposite sides of the frame 11 has a central portion provided with a shaft hole 113 to allow passage of the shaft 14. The wheel 13 of the frame unit 1 has a central portion provided with a rotation hole 131 rotatably mounted on the shaft 14.

The support unit 3 includes a bearing 34 mounted in the mounting hole 111 of the frame 11, an inner bushing 32 having a lower end mounted in the bearing 34, a retaining ring 33 secured on the frame 11 of the frame unit 1 and abutting the bearing 34 to retain the bearing 34 in the mounting hole 111 of the frame 11, and a top cover 31 mounted on a top of the frame 11 and abutting the inner bushing 32 to limit the inner bushing 32 on the frame 11 of the frame unit 1.

The bearing 34 of the support unit 3 is supported by the locating flange 12 of the support unit 3 and located between the retaining ring 33 of the support unit 3 and the locating flange 12 of the support unit 3. The bearing 34 of the support unit 3 is disposed between the frame 11 of the frame unit 1 and the inner bushing 32 of the support unit 3 so that the frame 11 of the frame unit 1 is rotatable on the inner bushing 32 of the support unit 3.

The inner bushing 32 of the support unit 3 has an upper end extending through and protruding outward from the top cover 31 of the support unit 3. The lower end of the inner bushing 32 is extended through the retaining ring 33 of the support unit 3 and is covered by the top cover 31 of the support unit 3.

The retaining ring 33 of the support unit 3 is mounted in the mounting hole 111 of the frame 11 and located above the locating flange 12 of the frame unit 1. The retaining ring 33 of the support unit 3 has a periphery provided with a plurality of fixing holes 331, and the support unit 3 further includes a plurality of fastening screws 332 extended through the fixing holes 331 of the retaining ring 33 and screwed into the screw bores 121 of the locating flange 12 to fasten the retaining ring 33 of the support unit 3 onto the locating flange 12 of the frame unit 1.

The brake unit 2 includes a control shaft 21 movably mounted in the inner bushing 32 of the support unit 3, a braking block 25 mounted on a lower end of the control shaft 21 to move in concert with the control shaft 21 and movable to press the wheel 13 of the frame unit 1, a lower toothed disk 24 mounted on the braking block 25, a limit sleeve 26 mounted on the lower end of the control shaft 21 and abutting a bottom of the braking block 25 to limit the braking block 25 on the control shaft 21, an upper toothed disk 22 locked onto the lower end of the control shaft 21 and movable to mesh with the lower toothed disk 24, a locking block 222 formed on the upper toothed disk 22 and detachably locked in the locating groove 122 of the locating flange 12 so that the locating flange 12 and the frame 11 of the frame unit 1 are locked onto the locking block 222, and an elastic member 23 biased between the braking block 25 and the upper toothed disk 22 to push the upper toothed disk 22 away from the lower toothed disk 24.

The lower toothed disk 24 of the brake unit 2 is secured in an open top 250 of the braking block 25. Preferably, the braking block 25 and the lower toothed disk 24 of the brake unit 2 are formed integrally.

The upper toothed disk 22 of the brake unit 2 has a central portion provided with a locking hole 221 locked onto the control shaft 21 so that the locking block 222 and the upper toothed disk 22 of the brake unit 2 are locked onto the control shaft 21. The locking hole 221 of the upper toothed disk 22 has a non-circular shape and preferably has a hexagonal shape.

The control shaft 21 of the brake unit 2 has a non-circular shape and preferably has a hexagonal shape. The control shaft 21 of the brake unit 2 has an upper end protruding outward from the inner bushing 32 of the support unit 3. The upper end of the control shaft 21 has an external thread 211. The lower end of the control shaft 21 is provided with a reduced mounting post 212. The mounting post 212 of the control shaft 21 is extended through the locking hole 221 of the upper toothed disk 22 and is inserted into the limit sleeve 26.

The limit sleeve 26 of the brake unit 2 is inserted into the braking block 25 and mounted on the mounting post 212 of the control shaft 21. The limit sleeve 26 of the brake unit 2 is locked onto the mounting post 212 of the control shaft 21 by a locking screw 260. The elastic member 23 of the brake unit 2 is received in the braking block 25 and mounted on the limit sleeve 26.

The braking block 25 of the brake unit 2 is disposed between the frame 11 and the wheel 13 of the frame unit 1 and has a periphery provided with a positioning lug 251 positioned in the positioning recess 112 of the frame 11 to position the frame 11 of the frame unit 1 onto the braking block 25 of the brake unit 2 so as to prevent the braking block 25 of the brake unit 2 from being deviated from the wheel 13 of the frame unit 1 when the upper toothed disk 22 and the lower toothed disk 24 of the brake unit 2 are meshed and operated. The braking block 25 of the brake unit 2 has a side provided with an oblique pressing face 252 that is movable to press the wheel 13 of the frame unit 1 to stop movement of the wheel 13 of the frame unit 1.

The operation unit 4 includes a housing 41 secured on the inner bushing 32 of the support unit 3, a drive seat 43 movably mounted in the housing 41 and connected with the control shaft 21 to drive the control shaft 21 of the brake unit 2 relative to the inner bushing 32 of the support unit 3, a pressing roll 432 mounted on the drive seat 43, a cam block 42 rotatably mounted in the housing 41 and abutting the pressing roll 432 to press the pressing roll 432 and the drive seat 43 toward the control shaft 21 of the brake unit 2, a restoring member 44 biased between the inner bushing 32 of the support unit 3 and the drive seat 43 to push the drive seat 43 away from the control shaft 21 of the brake unit 2, and a limit rod 411 mounted in the housing 41 to limit a movement interval of the cam block 42.

The drive seat 43 of the operation unit 4 has an upper end provided with a receiving recess 431 to receive the pressing roll 432 and has a lower end provided with an internal thread 430 screwed onto the external thread 211 of the control shaft 21 to lock the drive seat 43 of the operation unit 4 onto the control shaft 21 of the brake unit 2.

The restoring member 44 of the operation unit 4 is mounted on the drive seat 43 of the operation unit 4 and the control shaft 21 of the brake unit 2.

The cam block 42 of the operation unit 4 is located above the drive seat 43 of the operation unit 4 and has an inner wall provided with a non-circular operation hole 423 to allow insertion of a non-circular tool (not shown) so that the cam block 42 of the operation unit 4 can be rotated by the tool. The cam block 42 of the operation unit 4 has a periphery provided with an arc-shaped limit slot 424 which has two opposite ends each provided with a limit edge 425 that is movable to abut the limit rod 411 so as to limit a further movement of the cam block 42.

The cam block 42 of the operation unit 4 has a surface provided with a first receiving groove 420, a second receiving groove 421 and a pressing rim 422. The second receiving groove 421 of the cam block 42 is disposed between the first receiving groove 420 and the pressing rim 422 and has a depth smaller than that of the first receiving groove 420.

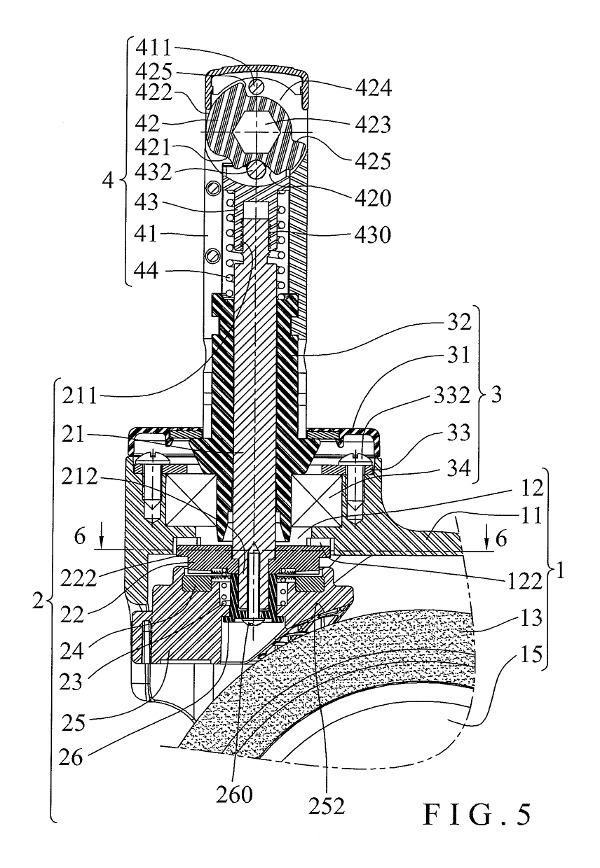

The first receiving groove 420 of the cam block 42 is movable to receive and release the pressing roll 432 as shown in FIG. 5 so that the drive seat 43 of the operation unit 4 and the control shaft 21 of the brake unit 2 are movable upward by an elastic force of the restoring member 44 of the operation unit 4, the locking block 222 of the brake unit 2 is movable upward into the locating groove 122 of the locating flange 12, and the pressing face 252 of the braking block 25 is movable upward away from the wheel 13 of the frame unit 1.

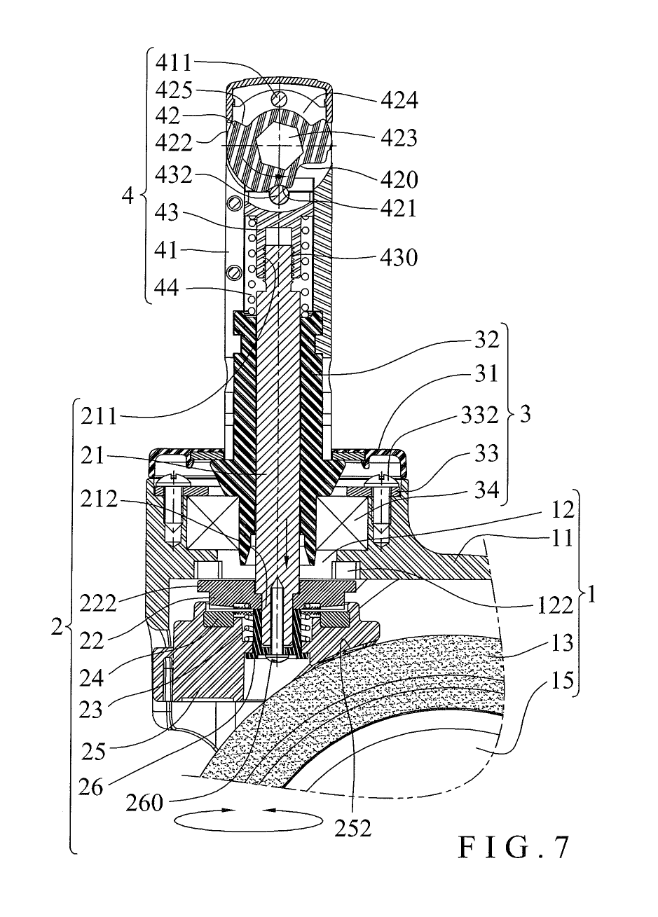

The second receiving groove 421 of the cam block 42 is movable to receive and press the pressing roll 432 as shown in FIG. 7 so that the drive seat 43 of the operation unit 4 and the control shaft 21 of the brake unit 2 are movable downward by the pressing roll 432 of the operation unit 4, and the locking block 222 of the brake unit 2 is movable downward to detach from the locating groove 122 of the locating flange 12.

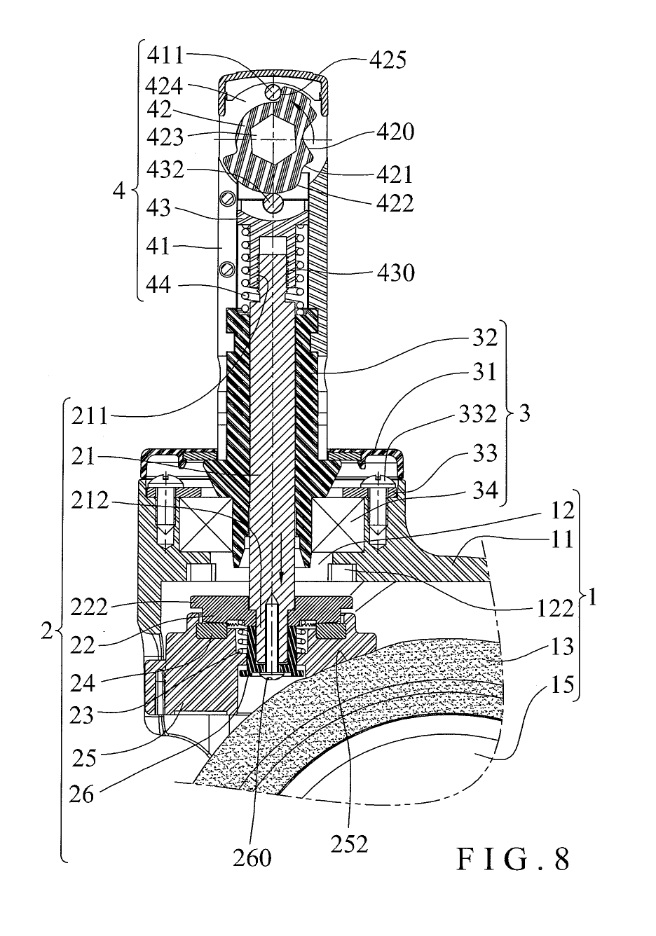

The pressing rim 422 of the cam block 42 is movable to press the pressing roll 432 as shown in FIG. 8 so that the drive seat 43 of the operation unit 4 and the control shaft 21 of the brake unit 2 are further movable downward by the pressing roll 432 of the operation unit 4, the pressing face 252 of the braking block 25 is movable downward to press the wheel 13 of the frame unit 1, the braking block 25 and the lower toothed disk 24 of the brake unit 2 are stopped by the wheel 13 of the frame unit 1, and the upper toothed disk 22 of the brake unit 2 is movable downward to mesh with the lower toothed disk 24.

The housing 41 of the operation unit 4 primarily consists of two semi-cylindrical shells which are combined together. The housing 41 of the operation unit 4 is locked onto the upper end of the inner bushing 32 by two screwing modules 413. The housing 41 of the operation unit 4 has a lower end inserted into the top cover 31 of the support unit 3 and has a periphery provided with two through holes 412 aligning with the operation hole 423 of the cam block 42 to allow passage of the non-circular tool.

In operation, referring to FIGS. 7 and 8 with reference to FIGS. 1-6, when the cam block 42 of the operation unit 4 is rotated, the first receiving groove 420 of the cam block 42 is moved to receive and release the pressing roll 432 as shown in FIG. 5, so that the drive seat 43 of the operation unit 4 and the control shaft 21 of the brake unit 2 are pushed and moved upward by the restoring force of the restoring member 44 of the operation unit 4, the locking block 222 of the brake unit 2 is moved upward into the locating groove 122 of the locating flange 12, and the pressing face 252 of the braking block 25 is moved upward to detach from the wheel 13 of the frame unit 1. In such a manner, the locking block 222 of the brake unit 2 is inserted into and locked in the locating groove 122 of the locating flange 12 so that the locating flange 12 of the frame unit 1 is locked onto the locking block 222 of the brake unit 2, and the frame 11 of the frame unit 1 is oriented by the locking block 222 of the brake unit 2 and cannot be swiveled relative to the control shaft 21 of the brake unit 2. At this time, the pressing face 252 of the braking block 25 is detached from the wheel 13 of the frame unit 1 so that the wheel 13 of the frame unit 1 can be rotated relative to the frame 11 of the frame unit 1 to perform a linear movement.

Alternatively, when the cam block 42 of the operation unit 4 is further rotated, the second receiving groove 421 of the cam block 42 is moved to receive and press the pressing roll 432 as shown in FIG. 7 so that the drive seat 43 of the operation unit 4 and the control shaft 21 of the brake unit 2 are moved downward by the pressing roll 432 of the operation unit 4, and the locking block 222 of the brake unit 2 is moved downward to detach from the locating groove 122 of the locating flange 12. In such a manner, the locking block 222 of the brake unit 2 is detached from the locating groove 122 of the locating flange 12 so that the locating flange 12 of the frame unit 1 is unlocked from the locking block 222 of the brake unit 2, and the frame 11 of the frame unit 1 is unlocked from the locking block 222 of the brake unit 2 and can be swiveled relative to the control shaft 21 of the brake unit 2. Thus, the wheel 13 of the frame unit 1 can be turned freely. At this time, the pressing face 252 of the braking block 25 is still detached from the wheel 13 of the frame unit 1 so that the wheel 13 of the frame unit 1 can be rotated relative to the frame 11 of the frame unit 1 to perform a linear movement.

Alternatively, when the cam block 42 of the operation unit 4 is further rotated, the pressing rim 422 of the cam block 42 is moved to press the pressing roll 432 as shown in FIG. 8 so that the drive seat 43 of the operation unit 4 and the control shaft 21 of the brake unit 2 are further moved downward by the pressing roll 432 of the operation unit 4, the pressing face 252 of the braking block 25 is moved downward to press the wheel 13 of the frame unit 1, the braking block 25 and the lower toothed disk 24 of the brake unit 2 are stopped by the wheel 13 of the frame unit 1, and the upper toothed disk 22 of the brake unit 2 is moved downward to mesh with the lower toothed disk 24. In such a manner, the pressing face 252 of the braking block 25 presses the wheel 13 of the frame unit 1 so as to stop movement of the wheel 13 so that the wheel 13 of the frame unit 1 is braked. At this time, the upper toothed disk 22 of the brake unit 2 meshes with the lower toothed disk 24 of the brake unit 2 so that the lower toothed disk 24 and the braking block 25 of the brake unit 2 are locked by the upper toothed disk 22 of the brake unit 2 and cannot be swiveled relative to the control shaft 21 of the brake unit 2, and the wheel 13 of the frame unit 1 is locked and cannot be turned freely.

Accordingly, when the pressing face 252 of the braking block 25 presses the wheel 13 to stop movement of the wheel 13, the upper toothed disk 22 meshes with the lower toothed disk 24 to lock the lower toothed disk 24 and the braking block 25 so that the wheel 13 is locked and cannot be turned freely when the wheel 13 is braked. In addition, the braking block 25 and the lower toothed disk 24 are formed integrally so that the lower toothed disk 24 will not be detached from the braking block 25 when the upper toothed disk 22 engages the lower toothed disk 24 too tightly due to an excessive reaction force from the wheel 13. Further, the wheel 13 is oriented, braked, moved and turned by operation of the cam block 42 to facilitate a user operating the wheel 13. Further, the control shaft 21 of the brake unit 2 is directly inserted into and mounted in the frame 11 of the frame unit 1 so that the castor assembly is assembled easily and quickly. Further, the castor assembly has a simplified construction and has a solid and stable structure.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A castor assembly, comprising:
a support unit;
a frame unit pivotally connected with the support unit;
a brake unit pivotally connected with the support unit and detachably locked onto the frame unit to releasably brake the frame unit; and
an operation unit mounted on the support unit and connected with the brake unit to drive the brake unit relative to the frame unit;
wherein the frame unit includes:
a frame having an upper end provided with a mounting hole;
a locating flange mounted in the mounting hole of the frame and having a bottom provided with a locating groove; and
a wheel rotatably mounted on a lower end of the frame;
the support unit includes:
a bearing mounted in the mounting hole of the frame; and
an inner bushing having a lower end mounted in the bearing;
the brake unit includes:
a control shaft movably mounted in the inner bushing of the support unit;
a braking block mounted on a lower end of the control shaft to move in concert with the control shaft and movable to press the wheel of the frame unit;
a lower toothed disk mounted on the braking block;
an upper toothed disk locked onto the lower end of the control shaft and movable to mesh with the lower toothed disk;
a locking block formed on the upper toothed disk and detachably locked in the locating groove of the locating flange so that the locating flange and the frame of the frame unit are locked onto the locking block; and
an elastic member biased between the braking block and the upper toothed disk to push the upper toothed disk away from the lower toothed disk;
the operation unit includes:
a housing secured on the inner bushing of the support unit;
a drive seat movably mounted in the housing and connected with the control shaft to drive the control shaft of the brake unit relative to the inner bushing of the support unit;
a pressing roll mounted on the drive seat;
a cam block rotatably mounted in the housing and abutting the pressing roll to press the pressing roll and the drive seat toward the control shaft of the brake unit; and
a restoring member biased between the inner bushing of the support unit and the drive seat to push the drive seat away from the control shaft of the brake unit.

2. The castor assembly of claim 1, wherein the locating flange and the mounting hole of the frame are formed integrally.

3. The castor assembly of claim 1, wherein
the frame of the frame unit has a periphery provided with a positioning recess;
the braking block of the brake unit has a periphery provided with a positioning lug positioned in the positioning recess of the frame to position the frame of the frame unit onto the braking block of the brake unit.

4. The castor assembly of claim 1, wherein the braking block and the lower toothed disk of the brake unit are formed integrally.

5. The castor assembly of claim 1, wherein the upper toothed disk of the brake unit has a central portion provided with a locking hole locked onto the control shaft so that the locking block and the upper toothed disk of the brake unit are locked onto the control shaft.

6. The castor assembly of claim 5, wherein
the locking hole of the upper toothed disk has a hexagonal shape;
the control shaft of the brake unit has a hexagonal shape.

7. The castor assembly of claim 1, wherein the braking block of the brake unit has a side provided with an oblique pressing face that is movable to press the wheel of the frame unit to stop movement of the wheel of the frame unit.

8. The castor assembly of claim 1, wherein the frame of the frame unit has a substantially inverted U-shaped profile.

9. The castor assembly of claim 1, wherein
the frame unit further includes:
a shaft extended through the frame and the wheel; and
two side covers mounted on two opposite sides of the frame to cover the shaft;
each of the two opposite sides of the frame has a central portion provided with a shaft hole to allow passage of the shaft;
the wheel of the frame unit has a central portion provided with a rotation hole rotatably mounted on the shaft.

10. The castor assembly of claim 1, wherein the support unit further includes:
a retaining ring secured on the frame of the frame unit and abutting the bearing to retain the bearing in the mounting hole of the frame; and
a top cover mounted on a top of the frame and abutting the inner bushing to limit the inner bushing on the frame of the frame unit.

11. The castor assembly of claim 10, wherein
the locating flange of the frame unit has a top provided with a plurality of screw bores;
the retaining ring of the support unit has a periphery provided with a plurality of fixing holes; and
the support unit further includes a plurality of fastening screws extended through the fixing holes of the retaining ring and screwed into the screw bores of the locating flange to fasten the retaining ring of the support unit onto the locating flange of the frame unit.

12. The castor assembly of claim 5, wherein
the brake unit further includes a limit sleeve mounted on the lower end of the control shaft and abutting a bottom of the braking block to limit the braking block on the control shaft;
the lower end of the control shaft is provided with a reduced mounting post;
the mounting post of the control shaft is extended through the locking hole of the upper toothed disk and is inserted into the limit sleeve;
the limit sleeve of the brake unit is inserted into the braking block and mounted on the mounting post of the control shaft;
the limit sleeve of the brake unit is locked onto the mounting post of the control shaft by a locking screw;
the elastic member of the brake unit is received in the braking block and mounted on the limit sleeve;
the braking block of the brake unit is disposed between the frame and the wheel of the frame unit.

13. The castor assembly of claim 1, wherein the lower toothed disk of the brake unit is secured in an open top of the braking block.

14. The castor assembly of claim 1, wherein
the cam block of the operation unit has an inner wall provided with a non-circular operation hole;
the housing of the operation unit has a periphery provided with two through holes aligning with the operation hole of the cam block.

15. The castor assembly of claim 1, wherein
the operation unit further includes a limit rod mounted in the housing to limit a movement interval of the cam block;
the cam block of the operation unit has a periphery provided with an arc-shaped limit slot which has two opposite ends each provided with a limit edge that is movable to abut the limit rod.

16. The castor assembly of claim 7, wherein
the cam block of the operation unit has a surface provided with a first receiving groove, a second receiving groove and a pressing rim;
the second receiving groove of the cam block is disposed between the first receiving groove and the pressing rim and has a depth smaller than that of the first receiving groove;
the first receiving groove of the cam block is movable to receive and release the pressing roll so that the drive seat of the operation unit and the control shaft of the brake unit are movable upward by an elastic force of the restoring member of the operation unit, the locking block of the brake unit is movable upward into the locating groove of the locating flange, and the pressing face of the braking block is movable upward away from the wheel of the frame unit;
the second receiving groove of the cam block is movable to receive and press the pressing roll so that the drive seat of the operation unit and the control shaft of the brake unit are movable downward by the pressing roll of the operation unit, and the locking block of the brake unit is movable downward to detach from the locating groove of the locating flange;
the pressing rim of the cam block is movable to press the pressing roll so that the drive seat of the operation unit and the control shaft of the brake unit are further movable downward by the pressing roll of the operation unit, the pressing face of the braking block is movable downward to press the wheel of the frame unit, the braking block and the lower toothed disk of the brake unit are stopped by the wheel of the frame unit, and the upper toothed disk of the brake unit is movable downward to mesh with the lower toothed disk.

17. The castor assembly of claim 10, wherein
the inner bushing of the support unit has an upper end extending through and protruding outward from the top cover of the support unit;
the control shaft of the brake unit has an upper end protruding outward from the inner bushing of the support unit;
the upper end of the control shaft has an external thread;
the drive seat of the operation unit has an upper end provided with a receiving recess to receive the pressing roll and has a lower end provided with an internal thread screwed onto the external thread of the control shaft to lock the drive seat of the operation unit onto the control shaft of the brake unit;
the housing of the operation unit is locked onto the upper end of the inner bushing;
the restoring member of the operation unit is mounted on the drive seat of the operation unit and the control shaft of the brake unit;
the cam block of the operation unit is located above the drive seat of the operation unit.

18. The castor assembly of claim 10, wherein
the locating flange of the frame unit has a stepped hollow inside;
the bearing of the support unit is supported by the locating flange of the support unit and located between the retaining ring of the support unit and the locating flange of the support unit;
the bearing of the support unit is disposed between the frame of the frame unit and the inner bushing of the support unit so that the frame of the frame unit is rotatable on the inner bushing of the support unit;
the lower end of the inner bushing is extended through the retaining ring of the support unit and is covered by the top cover of the support unit;
the retaining ring of the support unit is mounted in the mounting hole of the frame and located above the locating flange of the frame unit.
